(19) United States
(12) Patent Application Publication
(10) Pub. No.: US 2026/0063382 A1
(43) Pub. Date: Mar. 5, 2026

(54) MAGAZINE SPRING AND MAGAZINE ASSEMBLY

(71) Applicant: Sig Sauer, Inc., Newington, NH (US)

(72) Inventors: Derek A. Oaks, Manchester, NH (US); Jacqueline K. McNally, Rochester, NH (US); Stephen Marifiote, Epping, NH (US)

(73) Assignee: Sig Sauer, Inc., Newington, NH (US)

(21) Appl. No.: 19/314,164

(22) Filed: Aug. 29, 2025

Related U.S. Application Data
(60) Provisional application No. 63/689,427, filed on Aug. 30, 2024.

(51) Int. Cl. F41A 9/70; F16F 1/04; F41A 9/69

(52) U.S. Cl. CPC F41A 9/70; F16F 1/04; F41A 9/69

(57) ABSTRACT

A magazine spring includes intermediate coils each having a first end portion, a second end portion, and a waist portion between the first end portion and the second end portion. The waist portion has a width that is less than a width of at least one of the first end portion and the second end portion. A magazine tube is also disclosed. In one example, the magazine tube is made of sheet metal and includes grip indentations formed along forward corners of the magazine tube. The magazine tube may also define locating ribs for blank cartridges. A magazine spring having the narrow waist portion can be included in the magazine assembly so that the spring clears the locating ribs.

### RELATED APPLICATIONS

This application claims the benefit under 35 U.S.C. § 119(e) of U.S. Provisional Patent Application No. 63/689,427 filed on Aug. 30, 2024, the contents of which are incorporated herein by reference in its entirety.

### TECHNICAL FIELD

The present disclosure relates generally to detachable firearms magazines, and more particularly to a spring for a firearms magazine, a magazine assembly including the spring, and a magazine tube for a magazine assembly

### BACKGROUND

Design of firearms and firearm components involves many non-trivial challenges. A detachable magazine includes a magazine tube that extends from a bottom end to an open upper end that defines feed lips. The bottom end of the tube can be closed by a removable baseplate. A magazine spring is retained in the magazine tube in a somewhat compressed state between the baseplate and a follower, where the spring biases the follower, and any ammunition in the magazine, towards the feed lips at the upper end of the magazine tube. When installed in the magazine well, the top-most round is positioned in contact with the feed lips where it can be stripped from the magazine and loaded into the chamber during the loading cycle. When the magazine is fully loaded with ammunition, the follower is pushed down into the magazine and the spring is in a more compressed state. The magazine tube is typically made of metal or plastic. The tube can be straight or can have a curve or bend along its length, depending on the type and quantity of ammunition the magazine is designed to hold.

### SUMMARY

The present disclosure is directed to a spring for an ammunition magazine, a magazine tube with grip features and a locating rib, and a magazine assembly including the spring and/or tube. In one example embodiment, the spring is configured for a rifle magazine having a locating rib that is arranged to locate blank cartridges and/or cartridges having a projectile of reduced length that does not extend sufficiently to stop on the front wall of the magazine tube. In one example, the spring has a narrowed waist portion to avoid interference with the locating ribs, which extend laterally inward into the magazine tube. As a result, the spring can extend substantially the full forward-to-back dimension of the magazine envelope (e.g., at least 85% or more), unlike other magazines where the spring is located rearward of the locating rib. An increased spring coil length results in fewer coils being required to generate the same force at a given total spring length. Fewer spring coils results in a smaller solid height of the spring, which, without making other changes, can increase magazine capacity. The spring can be a stand-alone part, can be provided as part of a parts kit with a follower and spring plate, or can be part of a complete magazine assembly.

In another aspect of the present disclosure, a magazine tube includes one or more grip features that facilitate a user grasping the magazine. In one embodiment, the locating rib provides a vertical indentation on the outside of the magazine tube, where the indentation has a width and depth suitable for human fingers. For example, the user can wrap fingers around the front of the magazine with tips of the fingers engaging the recess of the locating rib. Such a grip facilitates a strong grip on the magazine for installing or removing the magazine. In another example the magazine is made of stamped and bent metal and includes finger indentations along forward margins of the magazine tube where the sidewall and front wall of the magazine tube intersect (e.g., along tube corners). The finger indentations facilitate a user gripping the magazine. Finger indentations can be sized for a single finger or for multiple fingers. In some embodiments, the gripping features can be part of a stamped metal magazine tube for rifle cartridges, and the magazine tube can be straight or curved.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the disclosed subject matter. Numerous variations and embodiments will be apparent in light of the present disclosure.

### BRIEF DESCRIPTION OF THE DRAWINGS

FIG. 1 illustrates a top, rear, and side isometric view of a magazine shown empty, in accordance with an embodiment of the present disclosure.

FIG. 2 illustrates a cross-sectional view of the magazine of FIG. 1 as viewed along line A-A, in accordance with an embodiment of the present disclosure.

FIG. 3 illustrates a top view of the magazine of FIG. 1

FIG. 4 illustrates a front perspective view of the magazine of FIG. 1.

FIG. 5 illustrates a front perspective view of the magazine of FIG. 1 loaded to capacity with rifle cartridges, in accordance with an embodiment of the present disclosure.

FIG. 6 illustrates a partial sectional view of the magazine of FIG. 5 and shows the ammunition stack, spring, and follower, in accordance with an embodiment of the present disclosure.

FIG. 7 illustrates a top view of the magazine of FIG. 5 shown loaded with cartridges 190, in accordance with an embodiment of the present disclosure.

FIG. 8 illustrates an isometric view of a magazine spring at free length, in accordance with an embodiment of the present disclosure.

FIG. 9 illustrates an isometric view of the magazine spring of FIG. 8 at solid height, in accordance with an embodiment of the present disclosure.

FIG. 10 illustrates a top view of an intermediate coil of a magazine spring, in accordance with an embodiment of the present disclosure.

FIG. 11 illustrates a front perspective view of a magazine, in accordance with another embodiment of the present disclosure.

FIG. 12 illustrates a side view of the magazine of FIG. 11.

FIG. 13 illustrates a front perspective view of a magazine, in accordance with another embodiment of the present disclosure.

FIG. 14 illustrates a side view of the magazine of FIG. 13.

The Figures depict various embodiments of the present disclosure for purposes of illustration only. For purposes of clarity, not every component may be labeled in every drawing. Furthermore, as will be appreciated, the figures are not necessarily drawn to scale or intended to limit the present disclosure to the specific configurations shown. Numerous variations, configurations, and other embodiments will be apparent from the following detailed discussion.

### DETAILED DESCRIPTION

Disclosed is a spring for an ammunition magazine, a components kit including the spring, a magazine tube with grip features, and a magazine assembly including the spring and/or magazine tube. In accordance with one embodiment, a spring is configured for use in a rifle magazine having locating ribs configured for blank ammunition cartridges. The spring coils have a turn width that is greater than the lateral distance between the locating ribs on the inside of the magazine tube. In another embodiment, a magazine spring for a rifle magazine has a narrowed waist portion configured to avoid interference with the tube's locating ribs. In such embodiments, the magazine spring can have an increased coil length and can extend, for example, at least 70%, at least 80%, at least 85%, or at least 90% of the front-to-rear length of the magazine envelope. These and other features of the magazine spring can be employed to increase the coil length, which can reduce the number of coils necessary for a given magazine tube, can increase spring pitch and spring force, and can reduce the solid height of the spring.

Advantageously, a magazine spring and magazine assembly in some embodiments can include combinations of features to increase magazine capacity by 1-3 rounds or more for a given magazine tube length. For example, the capacity of a magazine originally configured to hold 20-30 rounds of mini-action rifle ammunition can be increased by 2-3 rounds by retrofitting the magazine to include a magazine spring as disclosed herein.

Conventionally, magazines made of metal have not included grip features due to the difficult in making the indentations. As a result, grip features have been available only on polymeric magazines. It would be desirable to provide a metal magazine tube with one or more grip features (e.g., indentations) along front corners of the magazine tube. Thus, a need exists for improvements to metal magazine tubes. The present disclosure addresses this need.

In accordance with some embodiments, a magazine tube has one or more grip features configured to interface with the user's finger(s). The magazine tube is made of stamped and bent metal and includes finger indentations along front corners of the magazine tube where the sidewall and front wall intersect, for example. The finger indentations can be sized appropriately for a bare hand or a gloved hand, in accordance with some embodiments. In another example, one or both of the front corners of the magazine tube define an elongated indentation sized for several fingers. In yet another example, the vertical blank-locating rib has a depth and width to engage a user's fingers and enables enhanced grip on the magazine during use. Features of the magazine tube disclosed herein can be included individually or in combination with one another and can be present in one location or several locations on a magazine tube (e.g., along both sides). In addition, the grip features can be employed on magazine tubes that are straight or curved and magazines sized for a variety of rifle cartridges. Numerous variations and embodiments will be apparent in light of the present disclosure.

### Overview

It would be desirable to increase magazine capacity without adding to the overall size of a magazine. It would also be desirable to have a rifle magazine with a locating rib for blank ammunition, and a magazine spring that accommodates the locating rib while extending substantially the entire length (e.g., at least 85%) of the magazine envelope from front to back. In accordance with some embodiments, features of the spring can increase the ammunition capacity compared to existing magazine springs used in a magazine tube of the same length. Further, it would be desirable for a magazine made of sheet metal to include grip features, such as indentations on front corners of the magazine tube, that facilitate the user obtaining a secure grip on the magazine during use. The present disclosure addresses these needs and others by providing a magazine spring with an increased coil length and narrowed waist region, a magazine tube with grip features, and a magazine assembly incorporating one or more of these features. Numerous configurations and variations will be apparent in light of this disclosure.

As will be appreciated in light of the present disclosure, and in accordance with some embodiments, ammunition magazines configured as described herein are not limited to rifle ammunition and can be utilized with any of a wide range of ammunition and firearms. In accordance with some example embodiments, a magazine configured as described herein can be utilized with a rifle chambered for mini action (e.g., 5.56×45, 7.62×39, 5.45×39, and 6.5 Grendel), short action (e.g., .308 WIN), long action (e.g., 30-06 and .300 WIN MAG), or magnum action (e.g., .338 Lapua and 50 BMG), or other suitable ammunition. Other suitable host firearms and ammunition will be apparent in light of this disclosure.

Note that while generally referred to herein as a “locating rib” for consistency and case of understanding the present disclosure, the disclosed magazine tube is not limited to that specific terminology and alternatively this feature can be referred to, for example, as a shoulder control rib, a rib, a blank locating rib, or other terms. Also, as discussed herein, terms referencing direction, such as upward, downward, vertical, horizontal, left, right, front, back, etc., are used for convenience to describe embodiments of a magazine in an upright orientation. Embodiments according to the present disclosure are not limited by these directional references and it is contemplated that magazines and their components of the present disclosure could be used in any orientation.

### Example Embodiments

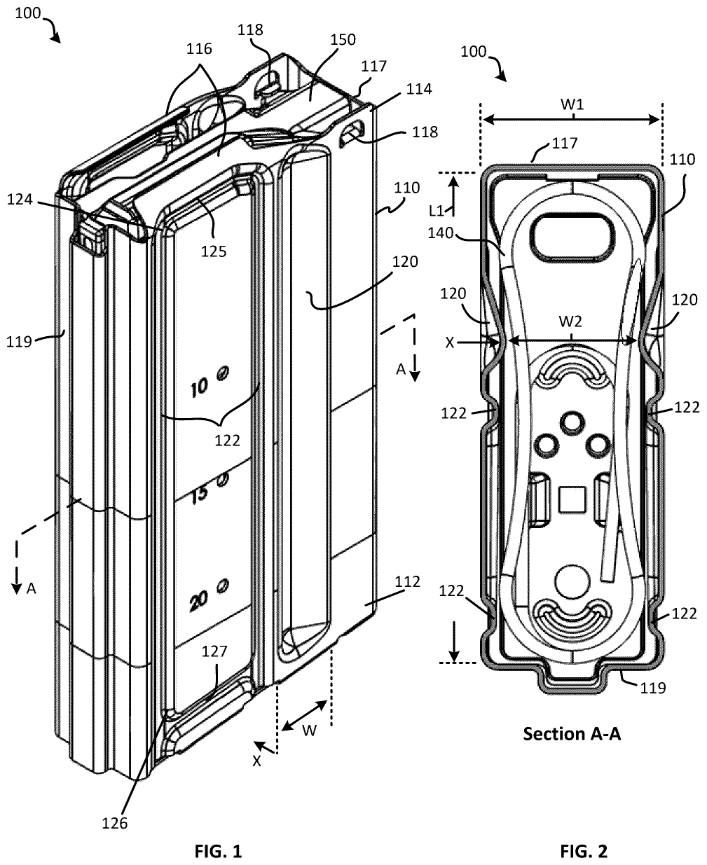

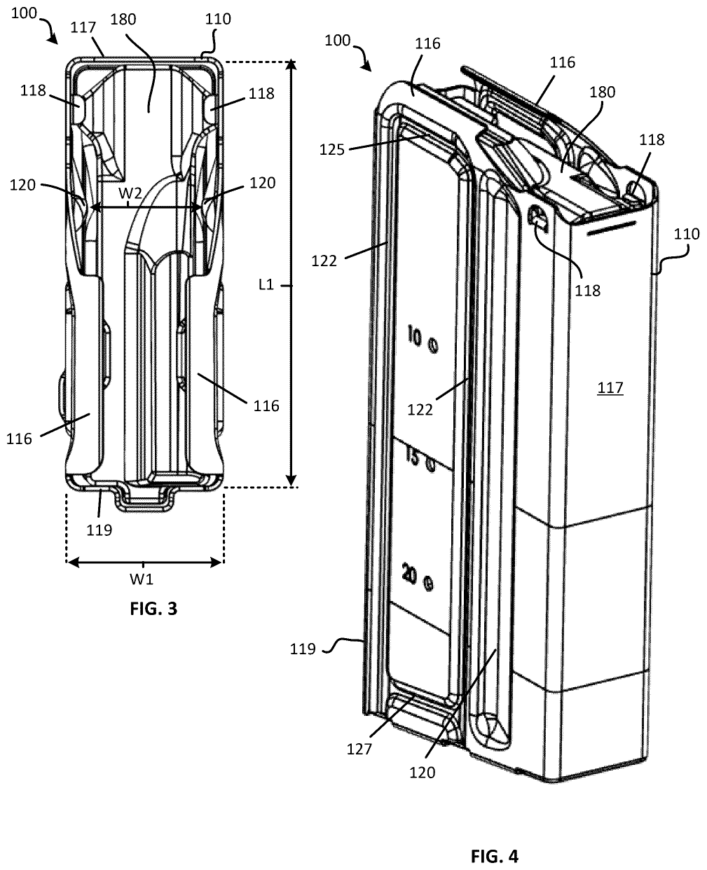

FIGS. 1-4 illustrate various views of a magazine 100, in accordance with an embodiment of the present disclosure. FIG. 1 illustrates a top, rear, and side isometric view of a magazine 100 shown empty; FIG. 2 illustrates a top view showing a cross section as viewed along line A-A of FIG. 1; FIG. 3 is a top view of the magazine of FIG. 1; and FIG. 4 is a top, front, and side perspective view of the magazine of FIG. 1. The magazine 100 includes a magazine tube 110 that extends from a bottom end 112 to a top end 114 defining feed lips 116. A follower 150 is urged towards the feed lips 116 by a magazine spring 140 (shown, e.g., in FIG. 2). When empty, the follower 116 stops on the feed lips 116 and/or protrusions 118 in the magazine tube 110.

A locating rib 120 extends inward from each side of the magazine tube 110. The locating ribs 120 are configured and arranged to engage a neck or shoulder of a rifle cartridge when the magazine 100 contains ammunition. In particular for blank ammunition, which lacks a projectile, locating ribs 120 prevent the ammunition from shifting forward in the magazine tube. When the magazine 100 is configured to accept more than one type of cartridge, for example, the locating ribs 120 serve the same purpose for cartridges having a projectile that does not extend forward sufficiently so that the front wall of the magazine tube 110 can serve as a forward stop to locate the cartridges in the tube 110. In this example, each locating rib 120 defines a recess having a width W (measured front to back) and a depth X sized for engagement by human fingers. For example, the locating rib 120 recess can be sized for bare fingers, gloved fingers, or both. In one embodiment, the width W is from 12-15 mm and the maximum depth X is from 3-5 mm.

Additional ribs 122 extend longitudinally along each side of the magazine tube 110. In this example, the additional ribs 122 are parallel with upper ends 124 joined by an upper or first horizontal rib 125 and lower ends 126 joined by a lower or second horizontal rib 127. The additional ribs 122 are positioned to engage the body of a rifle cartridge. For example, the body of the rifle cartridge is the larger diameter portion that is between the head and the neck. Note that the additional ribs 122 are parallel to one another and are also parallel to a rear wall and to a front wall of the magazine tube 110. The combination of the additional ribs 122, first horizontal rib 125, and second horizontal rib 127 generally defines a rectangular or trapezoidal geometry in this example. In other embodiments, such as where the magazine tube 112 is curved or bent, the additional ribs 122 can follow that curved or bent profile and define a corresponding region where the upper ends 124 are joined by the first horizontal rib 125 and the lower ends 126 are joined by the second horizontal rib 127.

The top view of FIG. 2 shows a cross section of the magazine of FIG. 1 as viewed along line A-A of FIG. 1, in accordance with an embodiment of the present disclosure. In this view, the locating ribs 120 extend inward from opposite sides of the magazine tube 110. Each locating rib 120 has an asymmetrical profile such that a location of the maximum depth X of the locating rib 120 is offset rearward from a center of the rib 120. Additional ribs 122 extend inward into a rear portion of the magazine tube 110. Note that the locating ribs 120 have a greater depth than that of the additional ribs 122 as appropriate for the locating ribs 120 to engage the shoulder of a cartridge casing and the additional ribs 122 to engage the body of a cartridge casing. In this example, the magazine tube 110 has an overall width W1 of about 27 mm and a width W2 between locating ribs 120 of about 20 mm.

The magazine spring 140 extends substantially an envelope length L1 measured from an inside of a front wall 117 to an inside of the back wall 119 of the magazine 100. For example, the spring 140 extends at least 70%, at least 75%, at least 80%, at least 85%, at least 90% or at least 95% of the envelope length L1 of the magazine 100. The magazine spring 140 is discussed in more detail below.

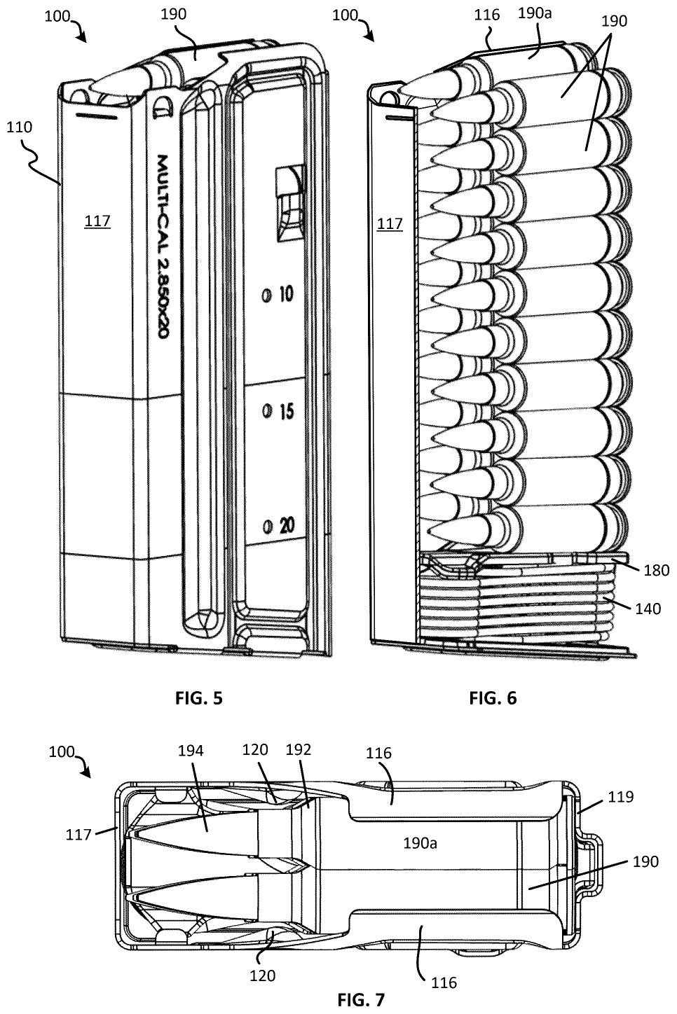

FIG. 5 illustrates a front perspective view of the magazine of FIG. 1 loaded to capacity with rifle cartridges 190, in accordance with an embodiment of the present disclosure. FIG. 6 illustrates a partial sectional view of the magazine of FIG. 5 and shows a stack of ammunition cartridges 190, a magazine spring 140 in a compressed state, and a follower 180 between the cartridges 190 and the spring 140, in accordance with an embodiment of the present disclosure. The cartridges 190 are arranged in an offset, double-stack configuration with a top-most cartridge 190a contacting one of the feed lips 116.

FIG. 7 illustrates a top view of the magazine of FIG. 5 shown loaded with cartridges 190. The top-most cartridge 190a abuts one of the feed lips 116 and the cartridges 190 are arranged in a double stack. The locating ribs 120 are positioned forward of the neck 192 of the cartridges 190 and thereby function as a stop that maintains an acceptable front-to-back position of the cartridges, such as when projectiles 194 are of reduced length or when the cartridges 190 are blank cartridges.

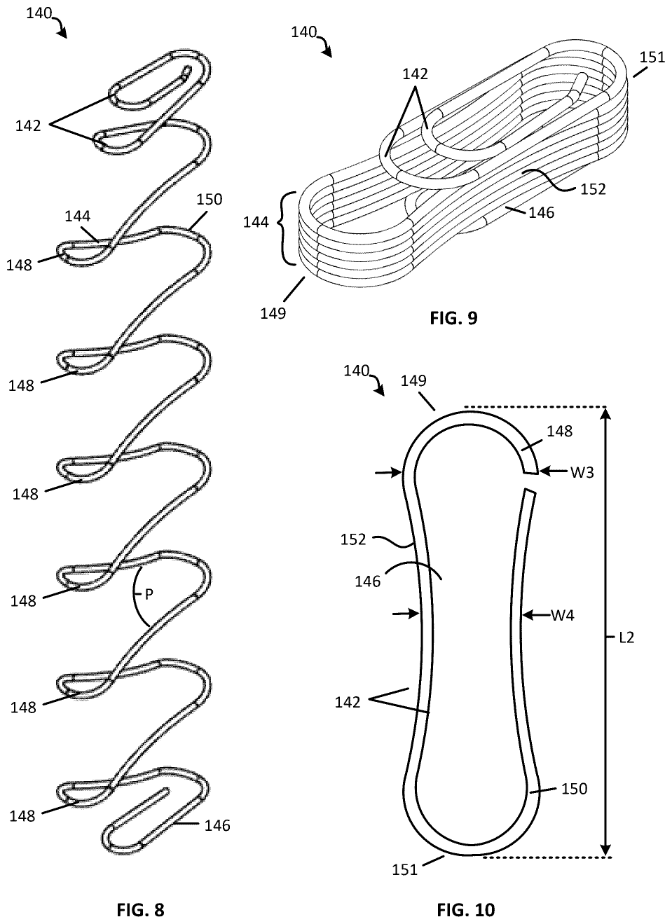

Turning now to FIGS. 8-10, various views show a magazine spring 140, in accordance with an embodiment of the present disclosure. FIG. 8 illustrates an isometric view of a magazine spring at free length, FIG. 9 illustrates an isometric view of the magazine spring 140 of FIG. 7 at solid height, and FIG. 10 illustrates a top view of an intermediate coil 144 of the magazine spring 140 shown in FIGS. 8-9. The spring includes one or more upper coils 142, at least one of which is configured to engage the follower 180, such as by receiving a protrusion on the bottom of the follower 180. In this example, the upper coils 142 have a reduced length compared to intermediate coils 144, which are generally regarded as the working coils of the spring 140. In other embodiments, the upper coil(s) 142 have the same coil length as the intermediate coils 144. The spring 140 includes a plurality of intermediate coils 144 having a coil length L2. In this example, the spring 140 has six intermediate coils 144. The spring 140 includes a bottom coil or lower coil 146 configured to engage a base plate or end cap of the magazine tube 110. In some embodiments, the bottom coil 146 can be omitted. In some embodiments, all coils of the spring 140 have the same coil length. In some embodiments, the spring has a coil length L2 from 2.25 to 3.0 inches (˜5.7-7.6 cm), including 2.4 to 2.8 inches (˜6.1-7.1 cm), 2.5 to 2.7 inches (˜6.3-6.9 cm), and about 2.6 inches (˜6.6 cm). The coil length L2 can be about 1.5 inches (3.8 cm) for smaller cartridges, in a range from 2-3 inches (5-7.6 cm) for other cartridges, and up to about 5 inches (12.7 cm), in some embodiments, depending on the dimensions of the magazine and the intended cartridge.

As can best be seen in FIG. 10, an intermediate coil 144 has a first turn 148 at a first end 149 and a second turn 150 at an opposite second end 151. One or both of the first turn 148 and the second turn 150 have a turn width W3 that is greater than width W2 between the locating ribs 120, such as shown in FIG. 2. In some embodiments, the turn width W3 is at least 110% of the width W2 between locating ribs 120. The first turn 148 and/or the second turn 150 define a turn of greater than 180°, including 190° or greater, 200° or greater, and 205° or greater. Due in part to the turns 148, 150 being greater than 180°, the spring 140 also has a narrowed waist portion 152 compared to the first and second turns 148, 150, where the waist portion 152 is configured to clear the locating ribs 120. In some embodiments, the waist width W4 (measured at narrowest point) is 95% or less of the turn width W3 or at least one of the first turn 148 and/or second turn 150. As shown in this example, the waist portion 152 and turns 148, 150 result in a continuous curve at least along the intermediate coils 144, resulting in a shape generally resembling an hourglass. In other embodiments, the waist portion 152 can include one or more straight sections. In one example, the spring 140 has a length L2 that is at least 70%, at least 80%, or at least 90% of a length L1 of the magazine tube 110.

The turn width W3 can be from 0.6 to 1.6 inches (˜1.5-4.1 cm), in some embodiments. The waist width W4 at the waist portion 152 can be as little as two wire diameters and up to 95% of the turn width W3. In the case where first turn 148 and second turn 150 are not identical, the waist width W4 can be up to 95% of the greater turn width. In some embodiments, only one of the first turn 148 and second turn 150 exceeds 180°, in other embodiments, both of the first turn 148 and the second turn 150 exceed 180°. The first turn 148 and the second turn 150 can be the same or different. IN some embodiments, waist width W4 is at most 95% of turn width W3, including at most 90%, at most 85%, at most 80%, at most 75%, at most 70%, at most 65%, at most 60%, at most 55%, and at most 50%. It has been found that even a 5% difference in waist width W4 compared to turn width W3 has been useful to allow the spring 140 to fit into a magazine having locating ribs 120 or other features that limit the magazine envelope's space for the spring 140. Note that the waist width W4 need not be at or near the center of the spring length and a reduction in width of the waist portion 152 need not occur at both sides of the spring. For example, in the example of FIG. 10, the waist portion 152 could be narrowed only on the right or left side as illustrated.

The magazine spring 140 can be configured for use with any magazine, but it is particularly well suited for use in rifle magazines having a locating rib 120. In some embodiments, the spring is made of coated music wire and has from 6-12 coils, including the upper coil(s), intermediate coils 144, and lower coil 146. In one example, the spring has 8.75 coils, a free length of about 13 inches (33 cm), a solid height of 0.6 inch (1.5 cm) or less, a pitch P of 25-45° (e.g., 30°-40° or about) 30° as measured between adjacent portions of the waist portion 152, and a spring force of 4-7 lbf. (17.8-31.1 N) (e.g., about 6 lbf. (26.7 N) at a length of 5.35 inches (13.6 cm)). In some embodiments, the spring 140 has a spring force from 1-20 lbf. (4.4-89 N), including 2-10 lbf. (8.9-44.5 N) and 4-7 lbf. (17.8-31.1 N). The spring 140 can be made of any suitable wire with any cross-sectional wire shape, including round, flat, rectangular, square, or hexagonal, to name a few examples.

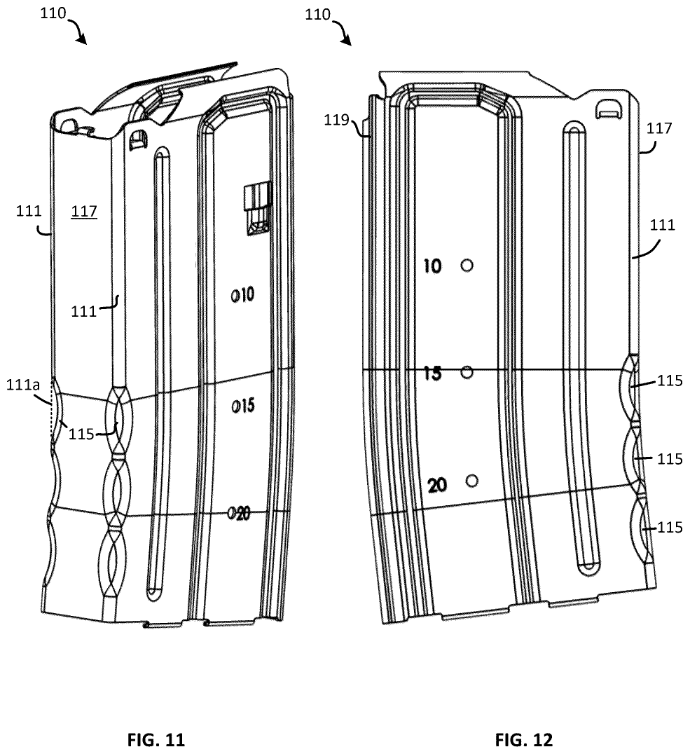

FIG. 11 illustrates a front perspective view of a magazine tube 110, in accordance with another embodiment of the present disclosure. FIG. 12 illustrates a side view of the magazine tube 110 of FIG. 11. In this example, the magazine tube 110 is made of stamped and bent sheet metal, such as steel or aluminum, and includes one or more grip indentations along a front corner 111 of the magazine tube 110. Here, each of the front corners 111 includes a plurality of grip indentations 115—three on each side in this example—where each of the grip indentations 115 is sized for engagement by a human finger. In some embodiments, the grip indentations 115 have a depth of 1-7 mm, such as 2-5 mm, or 3-4 mm. The depth can be measured from a theoretical sharp corner 111a of the magazine as defined by an intersection of the sidewall and front wall 117 of the magazine tube 110, or can be measured from an actual corner (e.g., whether rounded, flat, or square) of the magazine tube 110. The indentations can extend inward in a direction 45° to the front wall 117 of the magazine tube 110. In other embodiments, the grip indentations 115 extend into the magazine tube 110 at an angle of 30-60° to the front wall 117. Grip indentations 115 can be defined in the magazine tube 110 regardless of whether the magazine tube 110 is straight, curved, or bent.

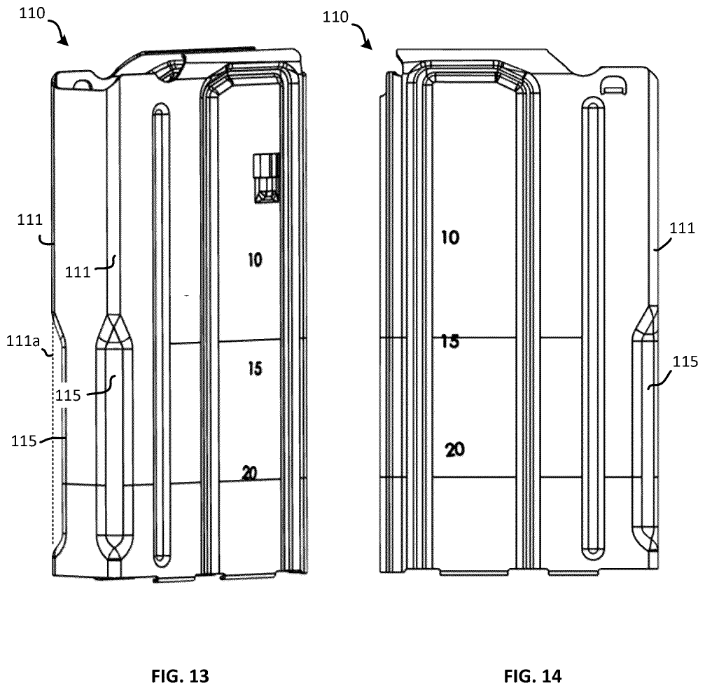

FIG. 13 illustrates a front perspective view of a magazine, in accordance with another embodiment of the present disclosure. FIG. 14 illustrates a side view of the magazine of FIG. 13. In this example, the magazine tube 110 is made of stamped and bent sheet metal, such as steel or aluminum, and includes one or more grip indentations 115 along a front corner 111 of the magazine tube 110. Here, each of the front corners 111 defines a vertically elongated grip indentation 115, where each of the grip indentations 115 is sized for engagement by a plurality of human fingers. In some embodiments, the grip indentations 115 have a depth of 1-7 mm, such as 2-5 mm, or 3-4 mm. The depth can be measured from a theoretical sharp corner 111a of the magazine as defined by an intersection of the sidewall and front wall 117 of the magazine tube 110, or can be measured from an actual corner 111 (e.g., whether rounded, flat, or square) of the magazine tube 110. The indentations can extend inward in a direction 45° to the front wall 117 of the magazine tube 110. In other embodiments, the grip indentations 115 extend into the magazine tube 110 at an angle of 30-60° to the front wall 117. Grip indentations 115 can be defined in the magazine tube 110 regardless of whether the magazine tube 110 is straight, curved, or bent.

### Further Example Embodiments

The following examples pertain to further embodiments, from which numerous permutations and configurations will be apparent.

Example 1 is a magazine spring comprising one or more upper coils, one or more lower coils between the one or more upper coils, and a plurality of intermediate coils between the one or more upper coils and the one or more lower coils. Each intermediate coil has a first end portion, a second end portion, and a waist portion between the first end portion and the second end portion, and a lower coil below the plurality of intermediate coils. The waist portion has a width that is less than a width of at least one of the first end portion and the second end portion.

Example 2 includes the magazine spring of Example 1, where at least one of the first end portion and the second end portion defines a turn of more than 180 degrees.

Example 3 includes the magazine spring of Example 1, where the first end portion and/or the second end portion spans a range of at least 200 degrees.

Example 4 includes the magazine spring of Example 3, where the first end portion and the second end portion each span a range of 200-210 degrees.

Example 5 includes the magazine spring of any of the foregoing Examples, where the first end portion, the second end portion, and the waist portion have a continuous curve.

Example 6 includes the magazine spring of any of the foregoing Examples, where the plurality of intermediate coils includes at least 6 intermediate coils.

Example 7 includes the magazine spring of any of the foregoing Examples, where the spring has a free length from 28 to 38 cm and a solid height of less than 2.5 cm. In another example, the free length is from 32 to 34 cm and the solid height is less than 2 cm.

Example 8 includes the magazine spring of Example 7, where the spring has at least 8 total coils.

Example 9 includes the magazine spring of any of the foregoing Examples, where the spring has a spring force from 5 to 90 Newtons.

Example 10 includes the magazine spring of Example 8, where the spring force is in a range from 9 to 45 Newtons

Example 11 includes the magazine spring of any of the foregoing Examples, where the spring has a coil pitch from 25-45° as measured between adjacent portions of the waist portion.

Example 12 includes the magazine spring of Example 11, where the coil pitch is 30-40°.

Example 13 includes the magazine spring of Example 8, where the spring force is in a range from 18-32 Newtons when the spring is installed in an unloaded magazine.

Example 14 includes the magazine spring of any of the foregoing Examples, where the spring has a coil length in a range from 5 to 7.5 cm.

Example 15 includes the magazine spring of any one of Examples 1-13, where the coil length is from 5 to 6 cm or from 6 to 7.5 cm.

Example 16 is a magazine comprising the magazine spring of any one of Examples 1-15, a magazine tube extending from a bottom end with a base plate to a top end defining feed lips, and a follower between the magazine spring and the feed lips when the magazine is in an assembled state.

Example 17 includes the magazine of Example 16, where the magazine tube defines locating ribs on opposite sides of the magazine tube, each of the locating ribs extending inward into the magazine tube and configured to engage a shoulder of a cartridge casing.

Example 18 includes the magazine of Example 17, where the width of the waist portion is less than a distance between the locating ribs.

Example 19 includes the magazine of Example 17 or 18, where at least one of the first end portion and the second end portion has a turn diameter that is greater than the distance between the locating ribs.

Example 20 includes the magazine of any one of Examples 17-19, where the magazine tube defines an envelope with an envelope length measured from an inside of a front wall to an inside of a back wall of the magazine, and where the magazine spring has a coil length that is at least 70% of the envelope length.

Example 21 includes the magazine of Example 20, where the coil length is at least 75% of the envelope length.

Example 22 includes the magazine of Example 20, where the coil length is at least 80% of the envelope length.

Example 23 includes the magazine of Example 20, where the coil length is at least 85% of the envelope length.

Example 24 includes the magazine of Example 20, where the coil length is at least 90% of the envelope length.

Example 25 includes the magazine of Example 20, where the coil length is at least 95% of the envelope length.

Example 26 includes the magazine of any one of Examples 16-25, where the magazine tube is made of sheet metal.

Example 27 includes the magazine of Example 26, where forward corners of the magazine each defines one or more grip indentations.

Example 28 includes the magazine of Example 27, where the one or more grip indentations comprises a vertically elongated indentation sized to accommodate two or more human fingers.

Example 29 includes the magazine of Example 27, where the one or more grip indentations comprises a plurality of finger grooves.

Example 30 includes the magazine of any one of Examples 27-29, where each of the one or more grip indentations has a depth of 1-7 mm measured from a theoretical corner between a sidewall and a front wall of the magazine tube.

Example 31 includes the magazine of Example 30, where the one or more grip indentations extend into the magazine tube at an angle from 30-60 degrees with respect to the front wall of the magazine tube.

Example 32 includes the magazine of Example 31, where the angle is from 40-50 degrees.

Example 33 includes the magazine of any one of Examples 17-32, where each of the locating ribs extends at least 80% of a vertical length of the magazine tube.

Example 34 includes the magazine of Example 33, where each of the locating ribs defines a groove in an outer surface of the magazine tube, the groove having a width of 10-15 mm.

Example 35 includes the magazine of Example 33 or 34 where the groove has a depth of 2-5 mm.

Example 36 includes the magazine of any one of Examples 16-35, where the magazine is configured for rifle cartridges.

Example 37 includes the magazine of Example 36, where the rifle cartridges are short action cartridges.

Example 38 includes the magazine of Example 36, where the rifle cartridges are long action cartridges.

Example 39 includes the magazine of Example 36, where the rifle cartridges are magnum action cartridges.

Example 40 includes the magazine of Example 36, where the rifle cartridges are mini action cartridges.

Example 41 includes the magazine of any one of Examples 16-40, where the magazine is configured as a multi-caliber magazine.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

1. A magazine spring comprising:
one or more upper coils;
one or more lower coils below the one or more upper coils;
a plurality of intermediate coils between the one or more upper coils and the one or more lower coils, the intermediate coils having a first end portion, a second end portion, and a waist portion between the first end portion and the second end portion; and
wherein the waist portion has a width that is less than a width of at least one of the first end portion and the second end portion.

2. The magazine spring of claim 1, wherein the plurality of intermediate coils includes at least 6 intermediate coils.

3. The magazine spring of claim 1, wherein at least one of the first end portion and the second end portion has a turn of more than 180 degrees.

4. The magazine spring of claim 3 having at least 8 total coils, a free length from 11 to 15 inches, and a solid height of less than 2.5 cm.

5. The magazine spring of claim 4, wherein the spring force is in a range from 9 to 45 Newtons (N).

6. The magazine spring of claim 5 having a coil pitch from 25-45°.

7. The magazine spring of claim 5, wherein the spring force is in a range of 18-30 N when the spring is installed in an unloaded magazine.

8. The magazine spring of claim 1 having a coil length in a range from 4.8 to 5.8 cm.

9. The magazine spring of claim 1 having a coil length in a range from 6.6 to 7.6 cm.

10. The magazine spring of claim 1, wherein the first end portion, the second end portion, and the waist portion have a continuous curve.

11. A magazine comprising:
a magazine tube extending from a bottom end with a base plate to a top end defining feed lips;
the magazine spring of claim 1, wherein the magazine spring is contained in or configured to be contained in the magazine tube; and
a follower between the magazine spring and the feed lips when the magazine is in an assembled state.

12. The magazine of claim 11, wherein the magazine tube defines locating ribs on opposite sides of the magazine tube, the locating ribs extending inward into the magazine tube and configured to engage a shoulder of a cartridge casing when the magazine is loaded to capacity.

13. The magazine of claim 12, wherein the width of the waist portion is less than a distance between the locating ribs.

14. The magazine of claim 12, wherein at least one of the first end portion and the second end portion defines a turn with a turn diameter that is greater than a distance between the locating ribs on opposite sides of the magazine tube.

15. The magazine of claim 11, wherein the magazine tube defines an envelope with an envelope length measured from an inside of a front wall to an inside of a back wall of the magazine, and wherein the magazine spring has a coil length that is at least 70% of the envelope length.

16. The magazine of claim 11, wherein the magazine tube is made of sheet metal, and wherein forward corners of the magazine each defines one or more grip indentations.

17. The magazine of claim 16, wherein the one or more grip indentations comprises a vertically elongated indentation sized to accommodate two or more human fingers.

18. The magazine of claim 16, wherein the one or more grip indentations comprises a plurality of finger grooves.

19. The magazine of claim 16, wherein each of the one or more grip indentations has a depth of 1-7 mm measured from a theoretical corner between a sidewall and a front wall of the magazine tube.

20. The magazine of claim 19, wherein the one or more grip indentations extend into the magazine tube at an angle from 30-60 degrees with respect to a plane of the front wall of the magazine tube.

21. The magazine of claim 12, wherein each of the locating ribs extends at least 80% of a vertical length of the magazine tube.

22. The magazine of claim 21, wherein each of the locating ribs defines a groove in an outer surface of the magazine tube, the groove having a width of 10-15 mm and a depth of 2-5 mm.
